(19) United States
(12) Patent Application Publication
(10) Pub. No.: US 2010/0236151 A1
(43) Pub. Date: Sep. 23, 2010

(54) COVER MECHANISM AND ELECTRONIC DEVICE USING SAME

(75) Inventor: HUAN-CHANG CHUNG, Shindian (TW)

Correspondence Address: Altis Law Group, Inc.;ATTN: Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/538,281

(22) Filed: Aug. 10, 2009

(30) Foreign Application Priority Data
Mar. 19, 2009 (CN) 200910300961.3

(51) Int. Cl. E06B 7/28

(52) U.S. Cl. 49/319

(57) ABSTRACT

An electronic device is provided including a housing and a cover mechanism . The housing defines a hole, and the cover mechanism covers the hole. The cover mechanism includes a cover member, a latching portion, and a locking member. The cover member includes a locking portion. The latching portion latches the cover member to the housing. The locking member includes elastic arms. The locking member is locked to the locking portion and configured to prevent the cover member from being separated from the housing by a resisting of the housing against the elastic arms.

### BACKGROUND

1. Technical Field

The present disclosure relates to cover mechanisms used in electronic devices.

2. Description of Related Art

Electronic devices usually have external interfaces (e.g., universal serial bus (USB)) for electrically connecting with external devices (e.g., printers), accessories (e.g., USB flash drives) or other electronic devices. Such external interfaces should be protected by cover mechanisms from e.g., dust or water, to maintain proper functioning.

The cover mechanisms usually include covers with latch mechanism. The covers are typically locked to the electronic devices by latch mechanism to cover the area through which the interfaces of electronic devices are exposed. However, the covers are often not permanently attached to the electronic device. Thus, the covers may easily be misplaced or lost when not locked to the electronic devices.

Therefore, there is room for improvement within the art.

### BRIEF DESCRIPTION OF THE DRAWING

Many aspects of the new cover mechanism and electronic device using the cover mechanism can be better understood with reference to the following drawings. The components in the drawings are not necessarily drawn to scale, the emphasis instead being placed upon clearly illustrating the principles of the new cover mechanism and electronic device using the cover mechanism. Moreover, in the drawings, like reference numerals designate corresponding parts throughout the several views.

FIG. 1 is an isometric view of an electronic device including an exemplary embodiment of a cover mechanism.

FIG. 2 is similar to FIG. 1, but showing another aspect thereof.

FIG. 3 is an enlarged view of a locking member of the cover mechanism shown in FIG. 1.

FIG. 4 is an isometric view of the cover mechanism shown in FIG. 1 in a locked position.

FIG. 5 is similar to FIG. 4, but in a released position.

FIG. 6 is similar to FIG. 5, but in an opened position.

FIG. 7 is similar to FIG. 6, but showing another aspect.

### DETAILED DESCRIPTION

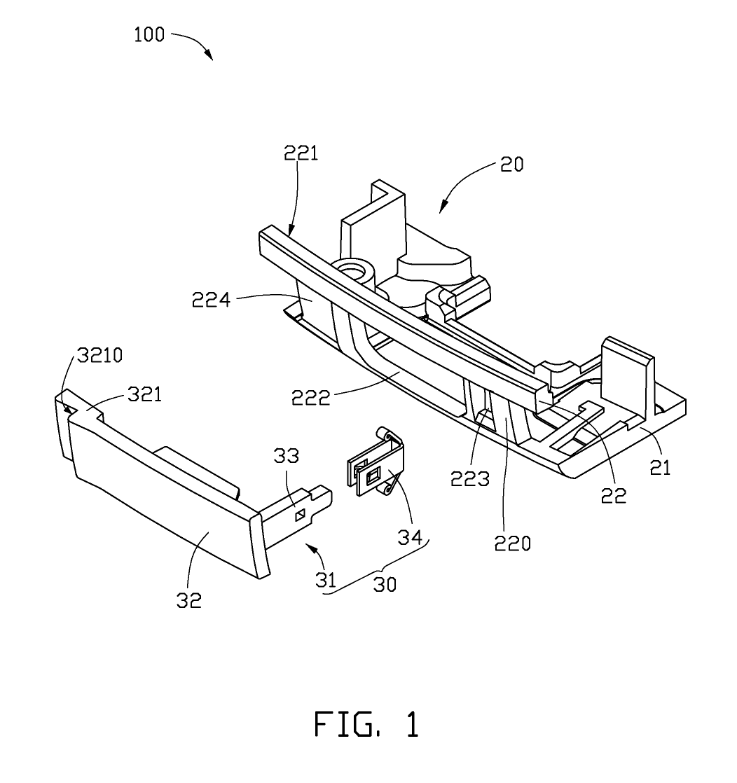

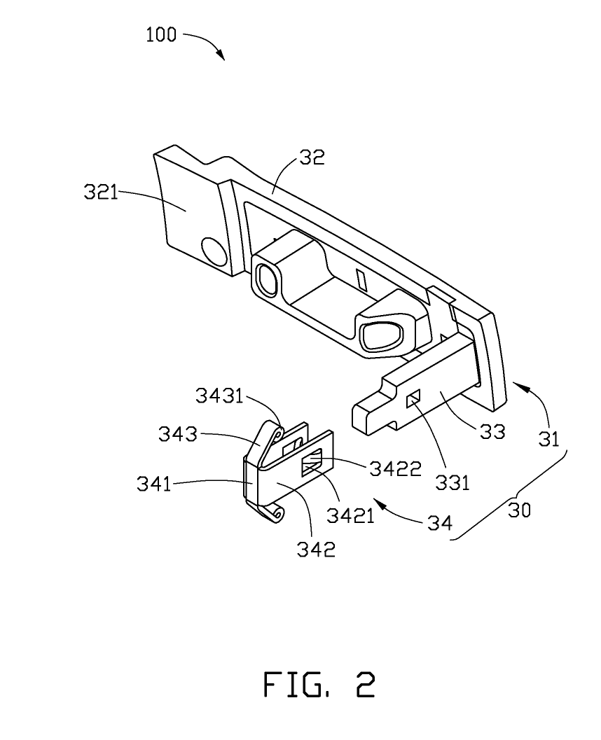

Referring to FIGS. 1 and 2, an exemplary electronic device (partially shown) includes a housing 20 and a cover mechanism 30. The cover mechanism 30 includes a cover member 31 and a locking member 34. The cover member 31 may be locked to the housing 20 to cover a hole 222 (e.g., an interface hole) defined in a sidewall 22 of the housing 20.

The housing 20 includes a bottom wall 21 connecting to the sidewall 22. The sidewall 22 includes an exterior surface 220, an interior surface 221. The sidewall 22 further defines a through receiving aperture 223 and a latching groove 224. The receiving aperture 223 and the latching groove 224 are located adjacent to and at two opposite sides of the hole 222. The receiving aperture 223 can be used to receive the locking member 34 into the housing 20. The latching groove 224 is used to secure the cover member 31 to the housing 20.

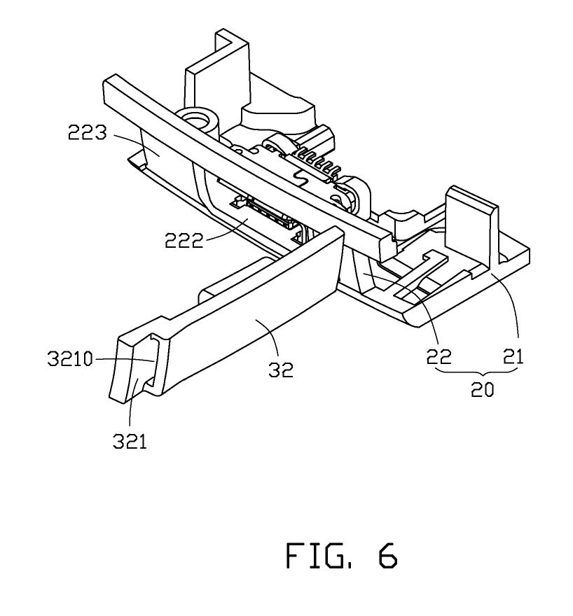

As shown in FIG. 2, the cover member 31 is made of an elastic member such as rubber and includes a base portion 32, a latching portion 321, and a locking portion 33. The latching portion 321 laterally extends from the base portion 32. The latching portion 321 is substantially the same as the latching groove 224 in structure, but slightly larger and is capable of being resiliently deformed for latching in the latching groove 224. The locking portion 33 protrudes substantially perpendicularly from the base portion 32 distal to the latching portion 321. The locking portion 33 defines a locking hole 331 therethrough for locking the locking member 34 to the locking portion 33. Referring to FIGS. 1 and 6, a handling hole 3210 is defined into the side of the base portion 32 proximate to the latching portion 321. The handling hole 3210 facilities an easy opening of the cover member 30 relative to the housing 20, e.g., using a finger.

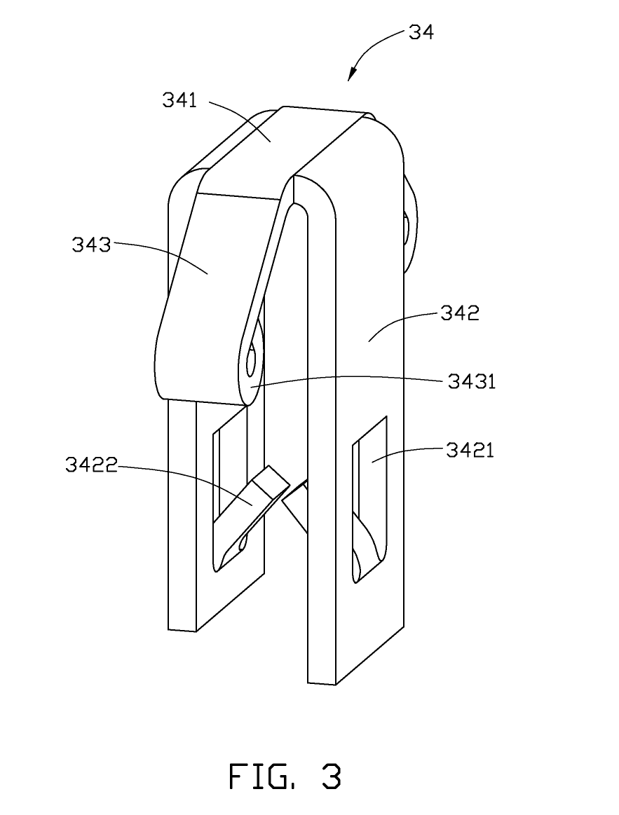

Referring further to FIG. 3, the locking member 34 is a metallic frame including a rigid resisting wall 341, two rigid opposite clamping arms 342 and two elastic arms 343. The two clamping arms 342 extend perpendicularly from two opposite sides of the resisting wall 341. The two clamping arms 342 define two aligned through slits 3421 . Each of the through slits 3421 has a locking block 3422 attached to its inner surface. The two locking blocks 3422 exposed upwardly out of the corresponding through slits 3421 towards each other. The locking blocks 3422 are used to lock into the locking hole 331.

The two elastic arms 343 slant from another two opposite sides of the resisting wall 341. Each elastic arm 343 has a curved resisting end portion 3431 distal to the resisting wall 341.

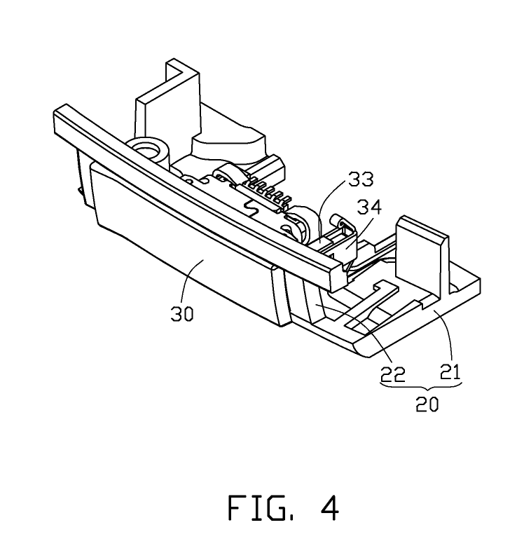

In FIG. 4, the cover mechanism 30 is in a locked position. In this position, the cover member 31 is locked to the housing 20 by the latching the latching portion 321 into the latching groove 224. The cover member 31 covers the hole 222 of the housing 20. The locking portion 33 is clamped to the locking member 34 between the clamping arms 342 by the inserting the locking blocks 3422 into the locking hole 331. The locking portion 33 and the locking member 34 are received inside the housing 20 through the receiving aperture 223 (see FIG. 1).

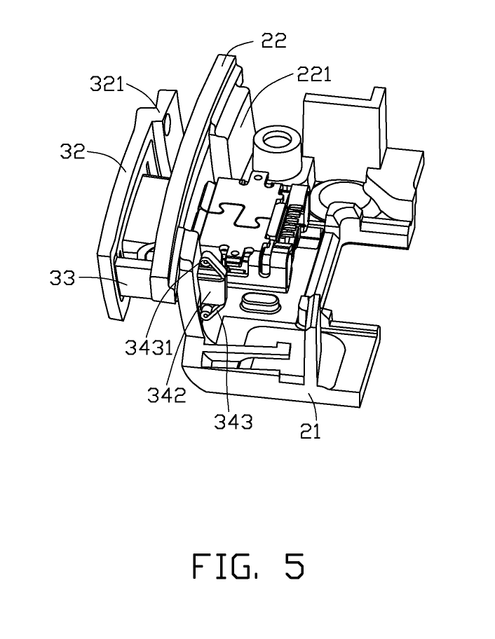

FIGS. 5 and 6 show a process of releasing the locking of the cover member 31 with the housing 20 from the locked position to a released position, and further to an opened position. In FIG. 5, the cover member 31 is pulled away from the housing 20 in a first direction (e.g., a horizontal direction). During this stage, the latching portion 321 is disengaged from the latching groove 224. The locking portion 33 slides outwardly within the receiving aperture 223, enabling the locked locking member 34 to simultaneously move towards the interior surface 221 of the housing 20. The cover member 31 reaches the released position, where the hole 222 is exposed from the cover member 31, but not completely exposed to the outside, until the resisting end portions 3431 of the elastic arms 3431 abuts the interior surface 221.

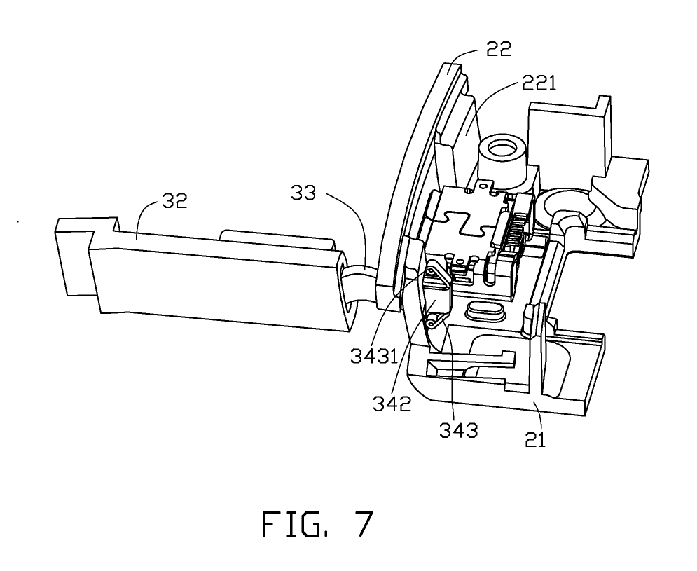

In FIGS. 6 and 7, the cover member 31 is bent to the opened position. During this stage, the resisting end portions 3431 are maintained to resist against the interior surface 221. The cover member 31 is moved towards a second direction (e.g., a clockwise direction), along with the base portion 32 by the bending of locking member 33. The latching portion 321 is inclined relative to the sidewall 22 except for the locking portion 33 still being received in the receiving aperture 223. The hole 222 is now completely exposed to the outside. The resisting of the interior surface 221 against the resisting end portion 3431 prevents the cover member 31 from detaching from the housing 20.

To close the cover mechanism 30, the above process is reversed and the cover member 31 is moved from the opened position to the released position, and further to the locked position.

It is to be understood, however, that even through numerous characteristics and advantages of exemplary embodiments have been set forth in the foregoing description, together with details of the structure and function of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A cover mechanism for covering a hole of a housing, comprising:
a cover member comprising a locking portion;
a latching portion configured to latch the cover member to the housing;
a locking member comprising elastic arms, the locking member locked to the locking portion and configured to prevent the cover member from being separated from the housing by the housing resisting against the elastic arms.

2. The cover mechanism as claimed in claim 1, wherein the locking member includes two opposite clamping arms, each of the two clamping arms forms a locking block, the locking portion defines a locking hole, and the locking portion is clamped between the two clamping arms by a locking of the two locking blocks in the locking hole.

3. The cover mechanism as claimed in claim 2, wherein each of the two clamping arms defines a through slit, each of the locking block attached inside the through slit and exposed upwardly out of the corresponding through slits towards with each other.

4. The cover mechanism as claimed in claim 2, wherein the locking member further comprises a resisting wall, the two clamping arms extend from two opposite sides of the resisting wall.

5. The cover mechanism as claimed in claim 4, wherein the elastic arms extend from two opposite sides of the resisting wall.

6. The cover mechanism as claimed in claim 4, wherein the cover member is elastic, the resisting wall and the clamping arms are rigid.

7. The cover mechanism as claimed in claim 1, wherein the cover member further comprises a base portion, the locking portion protrudes substantially perpendicularly from the base portion distal to the latching portion.

8. The cover mechanism as claimed in claim 1, wherein the housing defines a latching groove, the latching portion is elastic and substantially the same as the latching groove in structure, but slightly larger to be resiliently deformed to be latched in the latching groove.

9. An electronic device, comprising:
a housing defining a hole;
a cover mechanism covering the hole, comprising:
a cover member comprising a locking portion;
a latching portion configured to latch the cover member to the housing;
a locking member comprising elastic arms, the locking member locked to the locking portion and configured to prevent the cover member from being separated from the housing by the housing resisting against the elastic arms.

10. The electronic device as claimed in claim 9, wherein the housing includes a sidewall and a receiving aperture defined through the sidewall, the elastic arms locked to the locking portion and are configured to be elastically deformed to pass through the receiving aperture inside the housing, the locking portion slidably received in the receiving aperture.

11. The electronic device as claimed in claim 9, wherein the housing defines a latching groove, the latching portion is elastic and substantially the same as the latching groove in structure, but slightly larger to be resiliently deformed to be latched in the latching groove.

12. An electronic device, comprising:
a housing defining a hole;
a cover mechanism, comprising:
a latching portion configured to latch the cover mechanism to the housing;
a locking member comprising elastic arms;
a cover member comprising a locking portion locked to the locking member and configured for movement between:
a locked position, where the cover member is locked to the housing covering the hole by the latching of the latching portion, the elastic arms located inside the housing and away from the housing;
a released position, where the latching of the latching portion to the housing is released, and the locking portion and the elastic arms moves outwardly until the elastic arms resist against the housing;
an opened position, where a portion of the cover member is bent to expose the hole while being physically attached to the housing while maintaining the resisting of the elastic arms.

13. The electronic device as claimed in claim 12, wherein the housing includes a sidewall and a receiving aperture defined through the sidewall, the elastic arms locked to the locking portion and are configured to be elastically deformed to pass through the receiving aperture inside the housing, the locking portion slidably received in the receiving aperture.

14. The electronic device as claimed in claim 12, wherein the housing defines a latching groove, the latching portion is elastic and substantially the same as the latching groove in structure, but slightly larger to be resiliently deformed to be latched in the latching groove.

15. The electronic device as claimed in claim 12, wherein the locking member includes two opposite clamping arms, each of the two clamping arms forms a locking block, the locking portion defines a locking hole, and the locking portion is clamped between the two clamping arms by a locking of the two locking blocks in the locking hole.

16. The electronic device as claimed in claim 15, wherein each of the two clamping arms defines a through slit, each of the locking block attached inside the through slit and exposed upwardly out of the corresponding through slits towards with each other.

17. The electronic device as claimed in claim 15, wherein the locking member further comprises a resisting wall, the two clamping arms extend from two opposite sides of the resisting wall.

18. The electronic device as claimed in claim 17, wherein the elastic arms extend from two opposite sides of the resisting wall.

19. The electronic device as claimed in claim 17, wherein the cover member is elastic, the resisting wall and the clamping arms are rigid.
